(19) United States
(12) Patent Application Publication
(10) Pub. No.: US 2012/0034456 A1
(43) Pub. Date: Feb. 9, 2012

(54) MOLD RELEASE COMPOSITION AND SURFACE PROTECTIVE FILM

(76) Inventors: Takeshi Hasegawa, Saitama (JP); Takashi Shibuya, Saitama (JP); Hiroyuki Arai, Saitama (JP); Susumu Kurishima, Saitama (JP)

(21) Appl. No.: 13/265,169

(22) PCT Filed: Apr. 16, 2010
(86) PCT No.: PCT/JP2010/056849

§ 371 Date: Oct. 19, 2011

(30) Foreign Application Priority Data
May 1, 2009 (JP) 2009-111918

(51) Int. Cl. C08K 5/5415; B32B 9/00

(52) U.S. Cl. 428/336; 524/261

(57) ABSTRACT

Provided are a mold release composition, with which it is possible to form a transparent coating on the surface of which a photoresist cannot readily stick, and a surface protective film having a coating constituted by a cured product thereof. The mold release composition can include a binder resin, silicone oil and a metal alkoxide hydrolyzate. A content of the metal alkoxide hydrolyzate can be 50 to 500 parts by weight with respect to 100 parts by weight of the binder resin. The metal alkoxide can consist of or include tetraethoxysilane or tetramethoxysilane. The surface protective film can be obtained by forming a coating of the cured product of the mold release composition on a substrate.

This application is a U.S. national phase filing under 35 U.S.C. §371 of PCT Application No. PCT/JP2010/056849, filed Apr. 16, 2010, and claims priority under 35 U.S.C. §119 to Japanese patent application no. 2009-111918, filed May 1, 2009, the entireties of both of which are incorporated herein by reference.

### TECHNICAL FIELD

The presently disclosed subject matter relates to a mold release composition and a surface protective film using the same, particularly, relates to a mold release composition, with which a coating having excellent releasability and durability of releasability can be formed, and a surface protective film having a coating composed of a cured product of the mold release composition. The coating as a cured product and the surface protective film of the presently disclosed subject matter can be formed on or adhered to, for example, a surface of an original (photomask) for exposing an adhesive photoresist in a print substrate manufacturing procedure, etc. for use.

### BACKGROUND ART

Normally, a printed wiring board and a resin relief printing plate are produced by performing contact exposure with a photomask on an adhesive photoresist, such as a liquid photoresist. Therefore, without performing any treatment on a surface of the photomask, a part of the photoresist attaches to the photomask surface when peeling the photomask form the photoresist after finishing the exposure. The attached part of the photoresist remains on the photomask even by wiping off and results in a problem that exposure accuracy declines. As a countermeasure against such a circumstance, conventionally, a coating having releasability is formed on or a surface protective film provided with such a coating was adhered to a surface of the photomask facing to the photoresist, so that it is possible to prevent the photoresist from sticking to the photomask (the patent documents 1 and 2).

### RELATED ART REFERENCES

### Patent Document

Patent Document 1: Japanese Patent Unexamined Publication (Kokai) No. 2000-273412 (paragraph [0008])
Patent Document 2: Japanese Patent Unexamined Publication (Kokai) No. 2005-181565 (paragraph [0005])

### SUMMARY OF THE DISCLOSED SUBJECT MATTER

Many of coatings having releasability as such comprise a binder resin including silicone oil as a mold release component. In such coatings, in the case of a combination where compatibility of a binder resin with silicone oil is not good, there has been a problem that the coating whitened and an exposure failure occurs.

On the other hand, in the case of a combination where compatibility of a binder resin with silicone oil is good, a coating is not whitened and transparency can be obtained. However, because silicone oil is buried in the binder resin, releasability is hard to obtain. While, when keep adding silicone oil until releasability is provided to the coating surface, problems arise such that coating strength cannot be maintained and releasability declines when cleaning with a cleaning solvent because a large amount of silicone oil is added.

Therefore, as an aspect of the presently disclosed subject matter, a mold release composition, with which it is possible to form a transparent coating on a surface of which a photoresist cannot readily stick and a surface protective film having a coating constituted by a cured product of the mold release composition are provided. As another aspect, a mold release composition, with which it is possible to form a coating having durable releasability which prevents sticking of a photoresist for a long time, and a surface protective film having a coating constituted by a cured product of the mold release composition are provided.

As still another aspect, a mold release composition, with which it is possible to form a coating whose releasability is not declined even by a cleaning solvent, and a surface protective film having a coating constituted by a cured product of the mold release composition.

The present inventors devoted themselves to study, eventually found that, by forming a coating by curing a composition obtained by adding a metal alkoxide hydrolyzate to a binder resin and silicone oil, a coating having releasability can be realized even when compatibility of the silicone oil with the binder resin is good, and completed the presently disclosed subject matter.

Namely, a mold release composition of the presently disclosed subject matter comprises a binder resin, silicone oil and a metal alkoxide hydrolyzate.

A cured product of the presently disclosed subject matter is obtained by curing the mold release composition.

A surface protective film of the presently disclosed subject matter has a coating constituted by the cured product.

A photomask of the presently disclosed subject matter has the surface protective film adhered thereto via an adhesive layer.

With a mold release composition of the presently disclosed subject matter, it is possible to form a transparent coating on a surface of which a photoresist cannot readily stick. Also, it is possible to form a coating having durable releasability and a photoresist cannot readily stick for a long time. It is also possible to form a coating whose releasability does not decline even by a cleaning solvent.

By using a surface protective film of the presently disclosed subject matter, it is possible to obtain a transparent photomask on which a photoresist cannot readily stick. Also, it is possible to obtain a photomask having durable releasability, on which a photoresist cannot readily stick for a long time. Also, it is possible to obtain a photomask whose releasability does not decline even by a cleaning solvent.

### EXEMPLARY MODE FOR CARRYING OUT THE DISCLOSED SUBJECT MATTER

An explanation will be made on an embodiment of a mold release composition of the presently disclosed subject matter. The mold release composition of the presently disclosed subject matter comprises a binder resin, silicone oil and a metal alkoxide hydrolyzate.

As a binder resin constituting a mold release composition of the presently disclosed subject matter, polyvinyl chloride, polycarbonate, an acrylic resin, polybutyl methacrylate, polyester, polysulfone, polyphenylene oxide, polybutadiene, a hydrocarbon resin, a ketone resin, a phenoxy resin, polyamide, ethyl cellulose, vinyl acetate, an ABS resin, polyurethane, a melamine resin, an unsaturated polyester resin, an alkyd resin, an epoxy resin, a silicone resin, polyvinyl butyral, polyvinyl acetal and other resins may be used. Particularly, silicone resins having good compatibility with reactive silicone oil are possibly used for good transparency of a coating.

As a silicone resin, epoxy-modified silicone resin, alkyd-modified silicone resin, polyester-modified silicone resin, acrylic-modified silicone resin, methyl-type silicone resin and methylphenyl-type silicone resin, etc. may be used. Particularly, epoxy-modified silicone resin is possibly used in terms of hardness of a coating and solvent resistance.

A content of a binder resin is possibly 20 to 60% by weight of a total solid content of a mold release composition. When it is 20% by weight or more, strength of a coating after curing can be maintained, and when 60% by weight or less, it becomes possible to comprise a required and sufficient amount of other components explained later to a degree of achieving aspects of the presently disclosed subject matter.

Next, silicone oil is used for developing releasability in a coating. As such silicone oil, at least any one of dimethyl silicone oil, modified silicone oil and reactive silicone oil having at least one reactive functional group at terminal of a molecule may be used. By using reactive silicone oil as such, it becomes possible to easily react with other components constituting the mold release composition, consequently, releasability of an obtained coating can be maintained longer.

As modified silicone oil, alkyl-modified, polyether-modified, fluorine-modified, mercapto-modified, epoxy-modified, carboxyl-modified, higher fatty acid ester-modified, (metha)acrylic-modified and carbinol-modified silicone oil, etc. may be used.

As reactive silicone oil having a reactive functional group, those having an alkoxy group, mercapto group, carbinol group, epoxy group, amine group, acrylic group or carboxyl group as the reactive functional group may be used. Particularly, reactive silicone oil having an alkoxy group is possibly used for having high reactivity with later explained metal alkoxide and, thereby, it is strongly fixated in the coating, so that a photoresist cannot readily stick for a long time, releasability does not decline even by a cleaning solvent and the releasability can be maintained more.

As to those comprising a large amount of silicone oil not having any reactive functional group in its silicone oil composition, silicone oil is easily released from the coating and the releasability is hard to be maintained. Therefore, it is possible to comprise reactive silicone oil which easily reacts with other components constituting the mold release composition by 75% or more.

An adding ratio of reactive silicone oil is 0.5 to 5% by weight, possibly 1 to 2% by weight of a total solid content of the mold release composition. Releasability can be developed when 0.5% by weight or more, and when it is 5% by weight or less, arising of whitening can be prevented on a coating when conducting a finger rubbing test on the coating surface and it is also possible to prevent a transfer of silicone oil, which was not fixated in the coating, to a photoresist.

A metal alkoxide hydrolyzate is used to prevent silicone oil from being buried in a binder resin. As a result that it is possible to reduce silicone oil to be buried, a ratio of silicone oil in a coating can be reduced. As a metal element constituting a metal alkoxide, aluminum, zirconium, titanium and silicon may be used. As to kinds of alkoxide, methoxide, ethoxide, propoxide, isopropoxide, oxyisopropoxide and butoxide, etc. may be used.

Silicon alkoxide, which is an example of a metal alkoxide, forms a polysiloxane structure by thermal curing. As silicon alkoxide, for example, tetraalkoxysilane and trialkoxysilane, etc. may be mentioned.

As tetraalkoxysilane, for example, tetramethoxysilane, tetraethoxysilane, tetrapropoxysilane, tetrabutoxysilane, etc. may be mentioned and, among them, tetramethoxysilane and tetraethoxysilane are possible.

As trialkoxysilane, for example, methyltrimethoxysilane, methyltriethoxysilane, ethyltrimethoxysilane, ethyltriethoxysilane, propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane, γ-glycidoxypropyltrimethoxysilane, γ-glycidoxypropyltriethoxysilane, 3,4-epoxycyclohexylethyltrimethoxysilane, etc. may be mentioned.

As silicon alkoxide, tetraalkoxysilane is possible and tetramethoxysilane (methyl silicate) and tetraethoxysilane (ethyl silicate) are also possible particularly in terms of stability when made into an application solution and strength of a coating after curing.

As a metal alkoxide other than silicon, for example, zirconia propoxide, aluminum isopropoxide, titanium butoxide and titanium isopropoxide, etc. may be mentioned.

Those variety of metal alkoxides listed above may be used alone, or two or more kinds may be mixed for use.

A metal alkoxide hydrolyzate used in the presently disclosed subject matter is a compound generated by hydrolyzing those variety of metal alkoxides listed above in the presence of water, and compounds obtained by condensing after hydrolyzing (complete condensate and/or partial condensate) are also included. As such condensate, those having weight-average molecular weight (Mw) measured by the GPC method of, for example, 100 to 1000 or so calculated in terms of polystyrene are used.

A reaction of hydrolysis may be carried out by well-known methods. For example, a metal alkoxide is added to a large amount of alcohol solvent (for example, methanol or ethanol, etc.) and, in the presence of water and an acid catalyst (hydrochloric acid or nitric acid, etc.), brought to react at a predetermined temperature for predetermined time. Due to this reaction, a metal alkoxide is hydrolyzed and, successively, a condensation reaction starts, so that a hydrolyzate and/or a condensate thereof are obtained.

A degree of the hydrolysis can be adjusted by a water amount to be used. A degree of hydrolysis is obtained from a logical water amount required for performing hydrolysis condensation on all of hydrolyzable group, for example, all of alkoxy group in tetraalkoxysilane, that is, when assuming the hydrolysis rate is 100% when adding water in an amount of ½ the number of alkoxy group, hydrolysis rate (%)=(actual water amount added/logical water amount for hydrolysis)×100.

In the present embodiment, for example, a metal alkoxide hydrolyzate obtained in market may be used. As examples of commercially-supplied silicon alkoxide hydrolyzates, for example, “Alkoxy Oligomers” (for example, X-40-2308, KR-400 and KR-500, etc.) made by Shin-Etsu Chemical Co., Ltd. and Methyl silicate 51, Methyl silicate 53A, Ethyl silicate 40 and Ethyl silicate 48 made by COLCOAT Co., Ltd., etc. may be mentioned. The X-40-2308 (silane alkoxide condensate) includes a hydrolyzate of tetraalkoxysilane. It is the same in KR-400, KR-500, Methyl silicate 51, Methyl silicate 53A, Ethyl silicate 40 and Ethyl silicate 48.

Those examples of metal alkoxide hydrolyzate above may be used alone, or two or more kinds may be mixed for use.

The reason why it is possible to prevent silicone oil from being buried in a binder resin by using a metal alkoxide hydrolyzate is because, by adjusting a polarity of a mold release composition to be hydrophilic, it is possible to make hydrophobic silicone oil come to the surface of the coating.

A metal alkoxide hydrolyzate may be included possibly 50 parts by weight or more and more possibly 100 parts by weight or more with respect to 100 parts by weight of a binder resin. When it is 50 parts by weight or more, silicone oil easily comes to the surface of a coating and sufficient initial releasability can be obtained when made into a coating. On the other hand, when a content of a metal alkoxide hydrolyzate becomes too large, a content of a binder resin reduces relatively, as a result, there is a possibility that adhesiveness of a coating declines. Therefore, a content of a metal alkoxide hydrolyzate may be possibly 500 parts by weight or less and more possibly 300 parts by weight or less with respect to 100 parts by weight of a binder resin. When it is 500 parts by weight or less, appropriate adhesiveness of a coating can be obtained.

The mold release composition of the presently disclosed subject matter may be fabricated by blending the above-explained silicone oil, metal alkoxide hydrolyzate, binder resin and other components blended in accordance with need and dissolving in a suitable solvent. Particularly, to accelerate curing of a binder resin, a curing agent may be added as other component. As a curing agent for a silicone resin, it is possible to add aluminum chelate, titanium chelate or other well-known curing agents for silicone resin. As an other component, a silane coupling agent may be added, as well.

Next, an embodiment of a surface protective film of the presently disclosed subject matter will be explained. The surface protective film of the presently disclosed subject matter has a coating (cured product) formed by the mold release composition explained above.

As a substrate on which a coating is formed, polyester, ABS (acrylonitrile-butadiene-styrene), polystyrene, polycarbonate, acryl, polyolefin, cellulose resin, polysulfone, polyphenylene sulphide, polyether sulfone, polyetherether ketone, polyimide and other synthetic resin films may be used. Among them, those having excellent flatness are possibly used, and a uni-axially-stretched or bi-axially stretched polyester film is possible for having excellent mechanical strength, dimensional stability and, furthermore, stronger stiffness. A range of a thickness of the substrate is 1 μm or thicker, possibly 2 μm or thicker and furthermore possibly 4 μm or thicker and the upper limit of 50 μm or thinner, possibly 25 μm or thinner and furthermore possibly 12 μm or thinner.

On a substrate as such, a coating can be formed by blending the mold release composition explained above with other components in accordance with need, dissolving or dispersing the result in a suitable solvent to fabricate an application liquid, applying the application liquid on the substrate by a roll coating method, bar coating method, spray coating method, air knife coating method or other well-known method, then, curing by arbitrarily using a required method.

A thickness of a coating as such is not particularly limited, but the thinner, the more appropriate in terms of not deteriorating resolution of a photomask at the time of exposure. Specifically, it is 0.1 μm to 5 μm and possibly 0.2 μm to 2.5 μm or so in terms of surface hardness of the surface protective coat, abrasion of a coating due to repetitive contact exposure, initial releasability and durability of releasability.

On the surface with no coating formed thereon of the substrate, it is possible to provide an adhesive layer. As a result of providing an adhesive layer as such, it is easily adhered to a photomask and other objects of surface protecting.

As an adhesive layer as such, generally used acrylic type adhesives, rubber type adhesives, urethane type adhesives, silicone type adhesives and other well-known transparent adhesives may be used. Since the surface protective film of the presently disclosed subject matter is for the purpose of protecting an image, etc., the adhesive is also desirably transparent and has high weather resistance itself. As an adhesive as such, urethane crosslinkable or epoxy crosslinkable high-molecular-weight acrylic type adhesives are suitable. Also, adhesives having antistatic performance may be also used.

A thickness of an adhesive layer is possibly in a range with a lower limit of 0.5 μm or thicker, possibly 1 μm or thicker, or possibly 2 μm or thicker and an upper limit of 30 μm or thinner, possibly 15 μm or thinner and also possibly 7 μm or thinner so as not to harm the transparency (resolution) and to obtain proper adhesiveness. Also, a release film subjected to mold releasing treatment may be put appropriately on the surface of the adhesive layer, so that handleability of the surface protective film is not deteriorated due to the adhesiveness.

As explained above, according to the present embodiment, by adhering the surface protective film of the presently disclosed subject matter to an object of surface protection via an adhesive layer, a surface protective coat can be formed easily. It is also possible to prevent marks or dirt while maintaining hardness of coat surface of the surface protective coat. Furthermore, due to an improvement of optical properties, resolution can be improved, and exposure time can be made short so that productivity can be improved. Also, extremely high releasability from a photoresist can be maintained.

### EXAMPLES

Below, the presently disclosed subject matter will be explained furthermore by using examples. Note that “part” and “%” are based on weight unless otherwise mentioned.

### Example 1

On one surface of a transparent high molecular film having a thickness of 6 μm (Lumirror: TORAY Industries, Inc.), an application liquid including a mold release composition having a composition below was applied by bar coating and thermally cured at 120° C. for 5 minutes to form a coating having a thickness of about 0.5 μm. Furthermore, on the other surface, an application liquid for an adhesive layer having a composition below was applied and dried to form an adhesive layer having a thickness of about 4 μm, so that a surface protective film of an example 1 was produced. For better handleability, a polyethylene terephthalate release film having a thickness of 25 μm (MRB: Mitsubishi Polyester Film GmbH) was put on the adhesive layer.

### <Application Liquid Including Mold Release Composition>

| | | |
|---|---|---|
| binder resin | 1.85 | parts |
| (ES-1002T: Shin-Etsu Chemical Co., Ltd., solid content | | |
| 60%) | | |
| silicone oil having an alkoxy group at terminal | 0.05 | part |
| (X-22-1968: Shin-Etsu Chemical Co., Ltd., solid content | | |
| 100%) | | |
| silane alkoxide condensate | 2.22 | parts |
| (X-40-2308: Shin-Etsu Chemical Co., Ltd., active | | |
| constituent 100%) | | |
| curing agent | 0.1 | part |
| (titanium chelate, active constituent 100%) | | |
| silane coupling agent | 0.3 | part |
| (active constituent 100%) | | |
| solvent | 14.46 | parts |

### <Application Liquid for Adhesive Layer>

| | |
|---|---|
| acrylic ester copolymer | 10 parts |
| (Arontack SCL-200: solid content 40%, TOAGOSEI Co., | |
| Ltd.) | |
| Solvent | 20 parts |

### Example 2

Other than changing the application liquid including the mold release composition used in the example 1 to an application liquid including a mold release composition having a composition below, a surface protective film of an example 2 was produced in the same way as in the example 1.

### <Application Liquid Including Mold Release Composition>

| | |
|---|---|
| binder resin | 1.85 parts |
| (ES-1002T: Shin-Etsu Chemical Co., Ltd., solid content | |
| 60%) | |
| silicone oil having an alkoxy group at terminal | 0.02 part |
| (X-22-1968: Shin-Etsu Chemical Co., Ltd., solid content | |
| 100%) | |
| silane alkoxide condensate | 2.22 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 9.64 parts |

### Example 3

Other than changing the application liquid including the mold release composition used in the example 1 to an application liquid including a mold release composition having a composition below, a surface protective film of an example 3 was produced in the same way as in the example 1.

### <Application Liquid Including Mold Release Composition>

| | |
|---|---|
| binder resin | 1.85 parts |
| (ES-1002T: Shin-Etsu Chemical Co., Ltd., solid content | |
| 60%) | |
| silicone oil having an alkoxy group at terminal | 0.19 part |
| (X-22-1968: Shin-Etsu Chemical Co., Ltd., solid content | |
| 100%) | |
| silane alkoxide condensate | 2.22 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 9.64 parts |

### Example 4

Other than changing the application liquid including the mold release composition used in the example 1 to an application liquid including a mold release composition having a composition below, a surface protective film of an example 4 was produced in the same way as in the example 1.

### <Application Liquid Including Mold Release Composition>

| | |
|---|---|
| binder resin | 2.78 parts |
| (ES-1002T: Shin-Etsu Chemical Co., Ltd., solid content | |
| 60%) | |
| silicone oil having an alkoxy group at terminal | 0.05 part |
| (X-22-1968: Shin-Etsu Chemical Co., Ltd., solid content | |
| 100%) | |
| silane alkoxide condensate | 1.67 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 13.6 parts |

### Example 5

Other than changing the application liquid including the mold release composition used in the example 1 to an application liquid including a mold release composition having a composition below, a surface protective film of an example 5 was produced in the same way as in the example 1.

### <Application Liquid Including Mold Release Composition>

| | | |
|---|---|---|
| binder resin | 1.39 | parts |
| (ES-1002T: Shin-Etsu Chemical Co., Ltd., solid content | | |
| 60%) | | |
| silicone oil having an alkoxy group at terminal | 0.05 | part |
| (X-22-1968: Shin-Etsu Chemical Co., Ltd., solid content | | |
| 100%) | | |
| silane alkoxide condensate | 2.5 | parts |
| (X-40-2308: Shin-Etsu Chemical Co., Ltd., active | | |
| constituent 100%) | | |
| curing agent | 0.1 | part |
| (titanium chelate, active constituent 100%) | | |
| silane coupling agent | 0.3 | part |
| (active constituent 100%) | | |
| solvent | 14.15 | parts |

### Example 6

Other than changing the application liquid including the mold release composition used in the example 1 to an application liquid including a mold release composition having a composition below, a surface protective film of an example 6 was produced in the same way as in the example 1.

### <Application Liquid Including Mold Release Composition>

| | |
|---|---|
| binder resin | 0.93 part |
| (ES-1002T: Shin-Etsu Chemical Co., Ltd., solid content | |
| 60%) | |
| silicone oil having an alkoxy group at terminal | 0.05 part |
| (X-22-1968: Shin-Etsu Chemical Co., Ltd., solid content | |
| 100%) | |
| silane alkoxide condensate | 2.78 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 18.9 parts |

### Example 7

Other than changing the application liquid including the mold release composition used in the example 1 to an application liquid including a mold release composition having a composition below, a surface protective film of an example 7 was produced in the same way as in the example 1.

### <Application Liquid Including Mold Release Composition>

| | |
|---|---|
| binder resin | 1.70 parts |
| (ES-1002T: Shin-Etsu Chemical Co., Ltd., solid content | |
| 60%) | |
| silicone oil having a carbinol group at terminal | 0.06 part |
| (X-22-170DX: Shin-Etsu Chemical Co., Ltd., solid content | |
| 100%) | |
| silane alkoxide condensate | 2.00 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 13.0 parts |

### Example 8

Other than changing the application liquid including the mold release composition used in the example 1 to an application liquid including a mold release composition having a composition below, a surface protective film of an example 8 was produced in the same way as in the example 1.

### <Application Liquid Including Mold Release Composition>

| | |
|---|---|
| binder resin | 1.70 parts |
| (ES-1002T: Shin-Etsu Chemical Co., Ltd., solid content | |
| 60%) | |
| silicone oil having an epoxy group at terminal | 0.06 part |
| (X-22-163C: Shin-Etsu Chemical Co., Ltd., solid content | |
| 100%) | |
| silane alkoxide condensate | 2.00 parts |
| (X-40-2308: Shin-Etsu Chemical Co., Ltd., active | |
| constituent 100%) | |
| curing agent | 0.1 part |
| (titanium chelate, active constituent 100%) | |
| silane coupling agent | 0.3 part |
| (active constituent 100%) | |
| solvent | 13.0 parts |

### Comparative Example 1

Other than changing the application liquid including the mold release composition used in the example 1 to an application liquid including a mold release composition having a composition below, a surface protective film of a comparative example 1 was produced in the same way as in the example 1.

### <Application Liquid Including Mold Release Composition>

| | |
|---|---|
| binder resin | 4.4 parts |
| (ES-1001N: Shin-Etsu Chemical Co., Ltd., solid content | |
| 45%) | |
| silicone oil having an amine group at terminal | 0.1 part |
| (KF-8012: Shin-Etsu Chemical Co., Ltd., solid content | |
| 100%) | |
| curing agent | 0.1 part |
| (titanium chelate, active constituent 100%) | |
| solvent | 33.0 parts |

### Comparative Example 2

Other than changing the application liquid including the mold release composition used in the example 1 to an application liquid including a mold release composition having a composition below, a surface protective film of a comparative example 2 was produced in the same way as in the example 1.

### <Application Liquid Including Mold Release Composition>

| | |
|---|---|
| binder resin | 3.3 parts |
| (ES-1001N: Shin-Etsu Chemical Co., Ltd., solid content | |
| 45%) | |
| silicone oil having an alkoxy group at terminal | 0.1 part |
| (X-22-1968: Shin-Etsu Chemical Co., Ltd., solid content | |
| 100%) | |
| curing agent | 0.1 part |
| (titanium chelate, active constituent 100%) | |
| solvent | 33.0 parts |

The surface protective films obtained in the examples 1 to 8 and comparative examples 1 to 2 were evaluated as to following items. The results are shown in Table 1.

### [Evaluation on Initial Releasability]

An adhesive tape (cellophane tape CT405AP-18: NICHIBAN Co., Ltd.) was adhered to a coating of the surface protective film and 180° peel force at a peeling rate of 300 mm/min was measured by using a tensile testing machine (Compact Table-Top Universal Tester Shimadzu EZ-L: Shimadzu Corporation). Those exhibited a peel force of less than 0.1N/18 mm were marked “⊚”, those exhibited 0.1N/18 mm or more but less than 1N/18 mm were marked “◯” and those exhibited 1N/18 mm or more were marked “X”.

### [Evaluation of Cleaning Solvent Resistance]

A cleaning resistance test was conducted by using ethanol to check cleaning solvent resistance of a coating surface of the surface protective film. A cloth was immersed in a solvent and moved back and forth for 100 times with a load of 200 g. After that, an adhesive tape (cellophane tape CT405AP-18: NICHIBAN Co., Ltd.) was adhered to measure 180° peel force at a peeling rate of 300 mm/min. by a tensile test (Compact Table-Top Universal Tester Shimadzu EZ-L: Shimadzu Corporation). Those exhibited a peel force of less than 0.2N/18 mm were marked “⊚”, those exhibited 0.2N/18 mm or more but less than 1N/18 mm were marked “◯” and those exhibited 1N/18 mm or more were marked “X”.

### [Evaluation of Photoresist Adhesiveness Resistance]

A photoresist was closely adhered to a coating surface of the surface protective film, exposure was perconstituted by the back surface of the coating surface to cure an UV curable resin, then, an adhesive tape (cellophane tape CT405AP-18: NICHIBAN Co., Ltd.) was adhered to the coating of the surface protective film to measure 180° peel force at a peeling rate of 300 mm/min. by a tensile test (Compact Table-Top Universal Tester Shimadzu EZ-L: Shimadzu Corporation). Those exhibited a peel force of less than 0.2N/18 mm were marked “⊚”, those exhibited 0.2N/18 mm or more but less than 1N/18 mm were marked “◯” and those exhibited 1N/18 mm or more were marked “X”.

### [Evaluation of Transparency]

Haze of the surface protective film was measured by using a haze meter (HGM-2K: Suga Test Instruments Co., Ltd.) based on JIS K7105:1981. Those exhibited haze of lower than 1% were marked “⊚”, those exhibited 1% or higher but lower than 3% were marked “◯” and those exhibited 3% or higher were marked “X”.

### [Evaluation of Appearance]

An appearance of the surface protective film was observed visually. Those looked even by visual observation were marked “◯” and those with defects observed were marked “X”.

TABLE 1

| | | Cleaning | | | |
|---|---|---|---|---|---|
| | Initial | Solvent | Photoresist | Trans- | Appear- |
| | Releasability | Resistance | Resistance | parency | ance |
| Example 1 | ⊚ | ⊚ | ⊚ | ⊚ | ⊚ |
| Example 2 | ⊚ | ⊚ | ⊚ | ⊚ | ⊚ |
| Example 3 | ⊚ | ⊚ | ⊚ | ⊚ | ⊚ |
| Example 4 | ⊚ | ◯ | ◯ | ⊚ | ⊚ |
| Example 5 | ⊚ | ⊚ | ⊚ | ⊚ | ⊚ |
| Example 6 | ⊚ | ⊚ | ⊚ | ⊚ | ⊚ |
| Example 7 | ⊚ | X | X | ⊚ | ⊚ |
| Example 8 | ⊚ | ◯ | ◯ | ⊚ | ⊚ |
| Comparative | X | X | X | ⊚ | ⊚ |
| Example 1 | | | | | |
| Comparative | ⊚ | X | X | ⊚ | X |
| Example 2 | | | | | |

From Table 1, matters below can be understood. The surface protective films of the examples 1 to 8 have a coating formed by a mold release composition comprising silicone oil, a metal alkoxide hydrolyzate and a binder resin. Since compatibility of silicone oil with a binder resin was possible, they exhibited excellent transparency. Also, although compatibility of silicone oil with a binder resin is possible, because it comprises a metal alkoxide hydrolyzate, silicone oil was not buried in the coating and initial releasability was possible.

Since the surface protective films of the examples 1 to 6 use silicone oil having at least one alkoxy group at terminal of a molecular, the silicone oil was fixated in the coating and the releasability was durable comparing to that of the surface protective films of the examples 7 and 8.

In the surface protective film of the example 4, since an adding amount of a metal alkoxide hydrolyzate was small with respect to a binder resin (a little more than 60 parts with respect to 100 parts of a binder resin), silicone oil came to the surface was not fully fixated and the cleaning solvent resistance and photoresist resistance were inferior to those of the surface protective films of the examples 1 to 3. However, it was possible to obtain films with sufficiently satisfactory performance.

In the surface protective film of the example 7, silicone oil having a carbinol group was used. Because reactivity of a carbinol group is lower than that of an alkoxy group, the cleaning solvent resistance and photoresist resistance were inferior to those of the surface protective films of the examples 1 to 6. From the above, it was confirmed that by using reactive silicone oil having an alkoxy group, which is a reactive functional group, it was possible to improve the cleaning solvent resistance and photoresist resistance as well as initial releasability, namely, the usefulness was furthermore enhanced.

In the surface protective film of the example 8, silicone oil having an epoxy group was used. Because reactivity of an epoxy group is lower than that of an alkoxy group, the cleaning solvent resistance and photoresist resistance were a little inferior to those of the surface protective films of the examples 1 to 3.

The surface protective film of the comparative example 1 does not comprise a metal alkoxide hydrolyzate. Because compatibility of silicone oil with a binder resin was possible, the silicone oil was buried in the coating and the initial releasability could not obtained.

The surface protective film of the comparative example 2 does not comprise a metal alkoxide hydrolyzate. Because compatibility of silicone oil with a binder resin was possible, an amount of the silicone oil was increased to obtain initial releasability. However, because a ratio of silicone oil in the coating was high, the silicone oil could not be fixated in the coating and silicone oil released by a cleaning solvent or photoresist was wiped off, so that durability of releasability was not obtained. Also, because of the high ratio of silicone oil, arising of whitening of the coating could not be prevented when conducting a finger rubbing test on the coating surface. Furthermore, a transfer of silicone oil, which was not fixated in the coating, to a photoresist could not be prevented.

1. A mold release composition comprising a binder resin, silicone oil and a metal alkoxide hydrolyzate.

2. The mold release composition according to claim 1, wherein
the metal alkoxide hydrolyzate is included in an amount of 50 to 500 parts by weight with respect to 100 parts by weight of the binder resin.

3. The mold release composition according to claim 1, wherein
the metal alkoxide consists of tetraethoxysilane or tetramethoxysilane.

4. The mold release composition according to claim 1, wherein
the metal alkoxide hydrolyzate includes of a compound obtained by condensation after hydrolysis.

5. The mold release composition according to claim 4, wherein
the compound has a weight-average molecular weight measured by the GPC method of 100 to 1000 calculated in terms of polystyrene.

6. The mold release composition according to claim 1, wherein
the silicone oil is included in an amount of 0.5 to 5% by weight of a total solid content.

7. The mold release composition according to claim 1, wherein
the silicone oil includes any one of dimethyl silicone oil, modified silicone oil and reactive silicone oil having a reactive functional group.

8. The mold release composition according to claim 7, wherein
a content of the dimethyl silicone oil, the modified silicone oil and the reactive silicone oil in the silicone oil is 75% or more.

9. The mold release composition according to claim 1, wherein
the silicone oil includes reactive silicone oil having an alkoxy group at terminal of a molecular.

10. The mold release composition according to claim 1, wherein
the binder resin includes a silicone resin.

11. The mold release composition according to claim 10, further comprises a curing agent for a silicone resin.

12. A cured product obtained by curing the mold release composition according to claim 1.

13. A surface protective film having a coating, wherein
the coating is constituted by the cured product according to claim 12 and has a thickness of 0.1 to 5 μm.

14. A photomask, wherein the surface protective film according to claim 13 is adhered via an adhesive layer.

15. The mold release composition according to claim 2, wherein the metal alkoxide consists of tetraethoxysilane or tetramethoxysilane.

16. The mold release composition according to claim 2, wherein
the metal alkoxide hydrolyzate includes of a compound obtained by condensation after hydrolysis.

17. The mold release composition according to claim 3, wherein
the metal alkoxide hydrolyzate includes of a compound obtained by condensation after hydrolysis.

18. The mold release composition according to claim 16, wherein
the compound has a weight-average molecular weight measured by the GPC method of 100 to 1000 calculated in terms of polystyrene.

19. The mold release composition according to claim 17, wherein
the compound has a weight-average molecular weight measured by the GPC method of 100 to 1000 calculated in terms of polystyrene.

20. The mold release composition according to claim 2, wherein
the silicone oil is included in an amount of 0.5 to 5% by weight of a total solid content.
